(19) United States
(12) Patent Application Publication
(10) Pub. No.: US 2015/0088971 A1
(43) Pub. Date: Mar. 26, 2015

(54) USING A PROCESS REPRESENTATION TO ACHIEVE CLIENT AND SERVER EXTENSIBLE PROCESSES

(71) Applicant: Microsoft Corporation, Redmond, WA (US)

(72) Inventors: Subramanian Janardanan, Bellevue, WA (US); Kunal Garg, Bellevue, WA (US); Shashi Ranjan, Redmond, WA (US); Nirav Shah, Bothell, WA (US)

(73) Assignee: Microsoft Corporation, Redmond, WA (US)

(21) Appl. No.: 14/175,777

(22) Filed: Feb. 7, 2014

Related U.S. Application Data
(60) Provisional application No. 61/882,945, filed on Sep. 26, 2013.

(51) Int. Cl. H04L 29/06

(52) U.S. Cl. CPC H04L 67/42
USPC 709/203

(57) ABSTRACT

A system has actions that are performed on one or more clients, and other actions that are performed on a server. The computer system provides user input mechanisms that receive user inputs for customizing the computer system. A model of a customized process within the computing system is captured. Both server side and client side customizations are captured in a single process definition. The definition is stored and can be run later as is or as translated into an appropriate representation.

The present application is based on and claims the benefit of U.S. provisional patent application Ser. No. 61/882,945, filed Sep. 26, 2013, the content of which is hereby incorporated by reference in its entirety.

### BACKGROUND

Computer systems are currently in wide use. Some such computer systems are relatively large, including hundreds or thousands of forms that are interacted with by users. Such computer systems, at times, also need to be customized for deployment at a particular user's site.

By way of example, some such computer systems include business computer systems, such as customer relations management (CRM) systems, enterprise resource planning (ERP) systems, line-of-business (LOB) systems, etc. These types of business systems are often very large, including thousands of different forms that are used by users to interact with the system. These types of computer systems are also often sold as a base system that is then customized or further developed for deployment in a particular user's organization. Even after fully deployed and operational at a user's organization, the user may wish to perform even more customizations or enhancements on the system, for their particular use.

Currently, in order to customize such a system, the user often needs to employ a variety of different people, with varying knowledge, in order to make the customizations or enhancements. Some such people include designers that design the various customizations. Other people include developers that have detailed knowledge about the inner working of the business system, and who actually implement the customizations in the system. Thus, making customizations to a business system can be error prone and time consuming, and it can also be relatively costly.

The discussion above is merely provided for general background information and is not intended to be used as an aid in determining the scope of the claimed subject matter.

### SUMMARY

A system has actions that are performed on one or more clients, and other actions that are performed on a server. The computer system provides user input mechanisms that receive user inputs for customizing the computer system. A model of a customized process within the computing system is captured. Both server side and client side customizations are captured in a single process definition. The definition is stored and can be run later as is or as translated into an appropriate representation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system architecture in an authoring environment.

FIG. 2 is a flow diagram illustrating one embodiment of the operation of the architecture shown in FIG. 1 during authoring.

FIG. 3 is a block diagram of the architecture shown in FIG. 1, in a runtime environment.

FIG. 4 is a flow diagram illustrating one embodiment of the operation of the architecture shown in FIG. 3, during runtime.

FIG. 5 is a block diagram of the architectures shown in FIGS. 1 and 3, but deployed in a cloud architecture.

FIGS. 6-10 show various embodiments of mobile devices.

FIG. 11 shows one exemplary block diagram of a computing environment.

### DETAILED DESCRIPTION

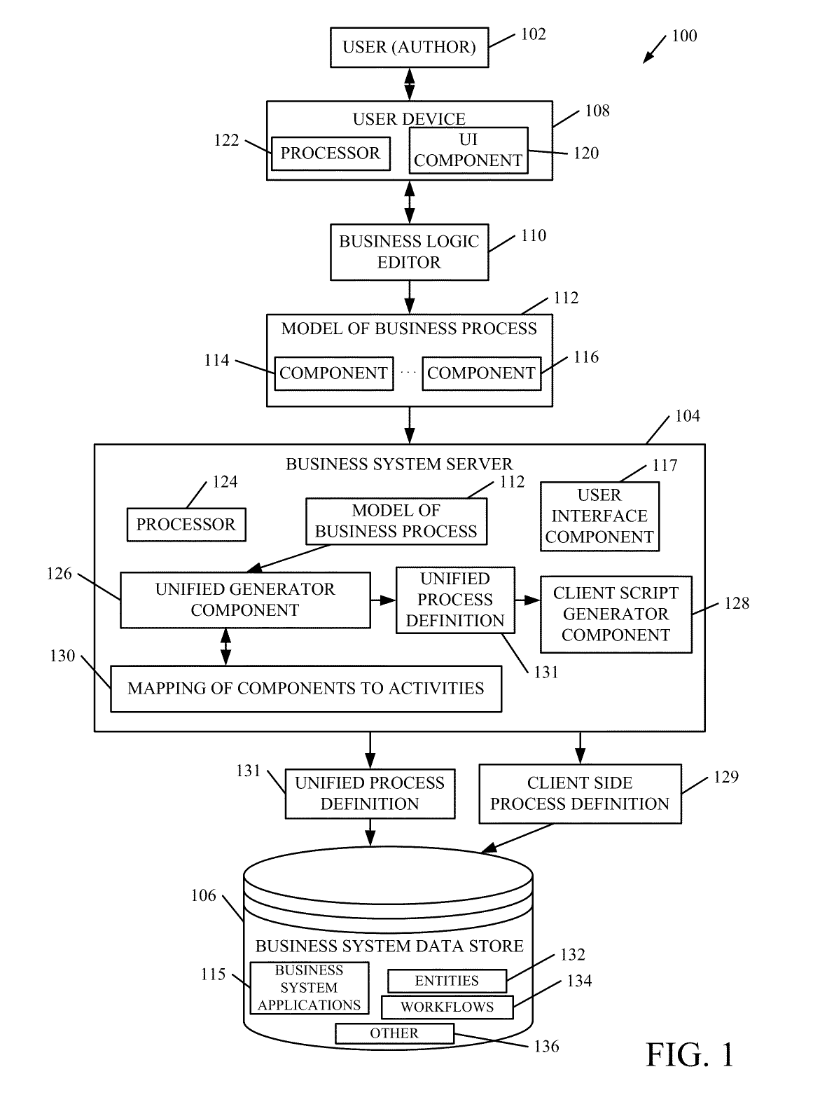

FIG. 1 is a block diagram of one illustrative business system architecture 100. Architecture 100 illustratively includes business logic editor 110, business system server 104, and business system data store 106. User 102 illustratively interacts with user input mechanisms on a wide variety of different kinds of user interface displays (or forms) in order to access and manipulate the business system which is run by business system server 104. The architecture 100 is shown to depict an authoring environment in which user 102 can use a user device 108 to interact with business logic editor 110 to generate a model 112 of customizations to business processes run by an underlying business system server 104. Business system server 104, itself, illustratively includes processor 124, user interface component 117, unified language generator component 126 and client script generator component 128. FIG. 1 shows that unified generator component 126 illustratively has access to a set of mappings 130 that map components within the model 112 of a business process to activities. The mappings 130 illustratively indicate which activities are relevant to which type of representation (e.g., server side, client side, which particular server or client side representation, etc.). Each activity is illustratively a set of actions that is performed in order to execute the business process modeled by model 112 (or other models or other business processes within the business system). The set of actions can be performed on the server side or client side and on multiple different kinds of clients.

FIG. 1 also shows that business system data store 106 illustratively includes business system applications 115 that can be run by either user device 108 (or another client device) and by server 104 (or both), in order to perform operations, activities and other actions and workflows to implement the business system. Data store 106 also illustratively stores business data. The business data can be stored, for example, as entities 132. Entities 132 illustratively represent, and allow user interaction with, various aspects of a computer system. For instance, a customer entity illustratively represents a customer. A vendor entity illustratively represents a vendor. An inventory entity represents an item of inventory. An opportunity entity represents a business opportunity. A sales order entity represents a sales order. A quote entity represents a quote, etc. Business system data store 106 also illustratively stores workflows 134 that can be performed by server 104 or user device 108 (or another client), or that can have actions that are performed in both places (both on the server and on the client). The server and/or client illustratively performs the actions in the workflows 134 in order to perform business processes and other tasks that are to be performed by the business system. Of course, business data store 106 can include other information 136 as well.

FIG. 1 also shows that architecture 100 is deployed for user 102 to author customizations to the business logic (e.g., the business processes, workflows, entities, etc.). Therefore, FIG. 1 shows that user 102 can access business logic editor 110 using user device 108. Business logic editor 110 generates user interface displays that allow user 102 to see various conditions, as well as actions that are to be performed under the various conditions, in order to establish or customize a business process flow that is followed in conducting a business process. These types of customizations can sometimes be described in terms of rules, and triggers. The rules define what is to happen (or an action or set of activities that are to be performed) and the triggers define when those rules fire (e.g., when they are triggered to be performed within the business system). Some of the activities can be performed on client devices while others can be performed on the server. The business system processes, and their customizations, once authored, are illustratively stored in business system data store 106.

Business logic editor 110 generates a model 112 of the business process. Model 112 is illustratively an abstract model of the business process that has been customized by author 102. The abstract model 112 illustratively captures both client side customizations and server side customizations as a single unified process definition. In one embodiment, model 112 illustratively includes process components 114-116. It will be noted that, while two components 114 and 116 have been shown in FIG. 1, a plurality of additional components can form the model 112 of the customized business process.

In one embodiment, each of the process components 114-116 represents a subfunction of the business process. By way of example, a subfunction within a business process executed by business system server 104 may be to create a record in business system data store 106. Of course, this is one exemplary subfunction and a wide variety of others can be represented by components 114-116 as well.

Before describing the operation of the business system in the authoring and runtime environment in more detail, a brief overview of the components in architecture 100 will first be provided. User device 108 can be a wide variety of different types of devices, such as a desktop computer, a laptop computer, a tablet computer, or a mobile device (such as a smartphone, etc.). User device 108 illustratively includes user interface component 120 and processor 122.

In one embodiment, processors 122 and 124 are illustratively computer processors with associated memory and timing circuitry (not separately shown). They are illustratively a functional part of the device or system to which they belong, and they are activated by the other items, components, or parts of the device or system to facilitate their functionality.

The user interface components 117 and 120 illustratively generate user interface displays either on their own, or under the control of other components or items. The user interface displays have user input mechanisms disposed thereon. The user can interact with the user input mechanisms in order to interact with and manipulate the business system. The user input mechanisms can illustratively take a wide variety of different forms, such as text boxes, check boxes, buttons, icons, links, tiles, drop down menus, etc. In addition, the user input mechanisms can be actuated in a wide variety of different ways as well. They can be actuated using a point and click device (such as a mouse or track ball), using a keyboard, a key pad, buttons, a joystick, thumb switches, etc. Further, they can be actuated using a soft keyboard or key pad, or, where the device they are generated from includes speech recognition components, they can be actuated using speech commands. Further, where the display device on which they are displayed is a touch sensitive screen, they can be actuated using touch gestures.

Business system data store 106 is shown as a single data store that is accessible by business system server 104. It will be noted, however, that it can also be formed of multiple different data stores. The one or more data stores can also be local to server 104, or remote therefrom. In addition, where multiple data stores are used, all can be local to server 104, all can be remote from server 104, or some can be local while others are remote.

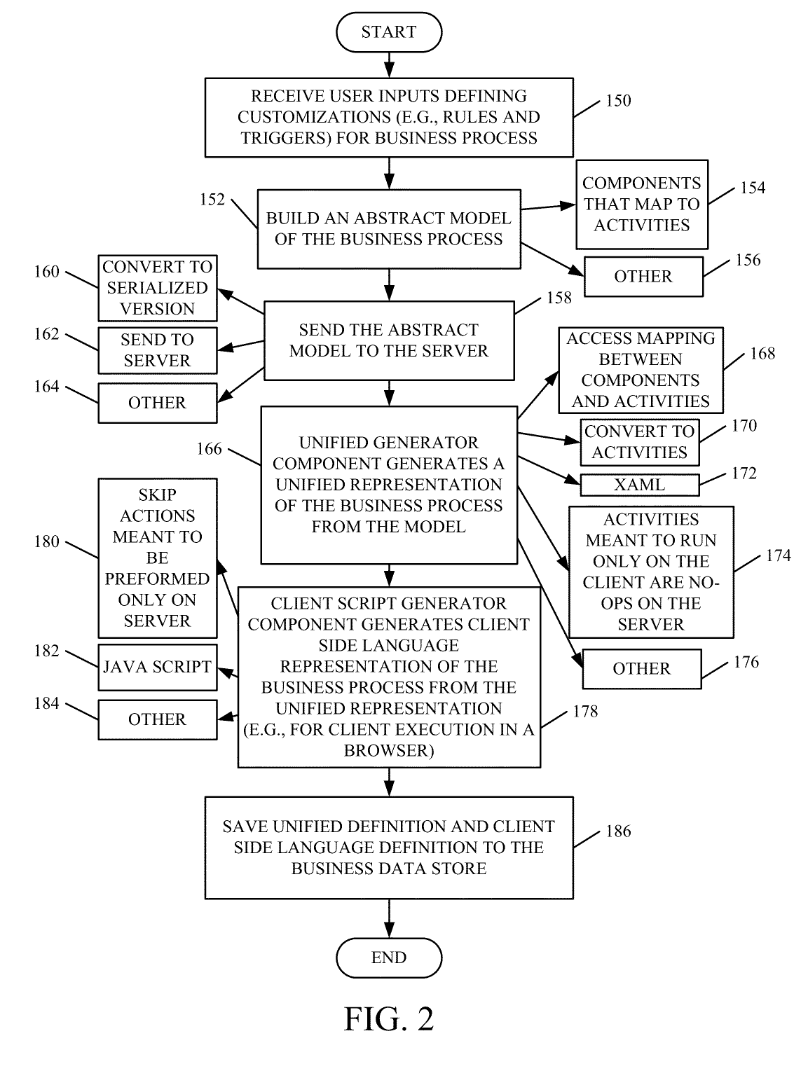

FIG. 2 is a flow diagram illustrating one embodiment of the operation of architecture 100, shown in FIG. 1, in an authoring environment in which user 102 authors customizations to business processes for execution by business system server 104 and one or more client devices. FIGS. 1 and 2 will now be described in conjunction with one another.

Business logic editor 110 first generates user interface displays that allow user 102 to input customizations to a given business process. For instance, the user can input rules and triggers or other kinds of customizations to a given business process. Receiving the user inputs defining those customizations is indicated by block 150 in FIG. 2. In one embodiment, the user only declares what customization he or she wants, and need not be concerned about which are client side customizations and which are server side, or which client side customizations will only run on which clients, etc. The common definition that is generated and stored is one true copy of all customizations that the user wants to identify. The system uses the mapping of activities to identify client/server and client only versions accordingly.

Business logic editor 110 then builds an abstract model of the business process, along with the customizations. This is indicated by block 152 in FIG. 2. By way of example, the abstract model can illustratively be made up of process components 154 (represented by 114-116 in FIG. 1) that map to a variety of activities or other actions or subfunctions of the business process. The activities can, for example, be mapped to where they are performed (e.g., client or server) and which particular clients they are performed on and which particular activities are valid for which particular representations (e.g., a client representation, a server representation, etc.). The abstract model of the business process can include other items as well, and this is generally indicated by block 156 in FIG. 2.

The model is then sent to business system server 104. This is indicated by block 158. This can be done in a wide variety of different ways. For instance, the model can be captured in a client side modeling language, or in a server side modeling language. In the embodiment discussed herein, the model is serialized using a text-based serialization notation that represents the data structures corresponding to model 112. By way of example, one client side representation mechanism is java script. In that case, the serialization can be generated using a java script object notation (JSON). Of course, the client side representation can be generated using other languages or representation mechanisms as well, and the abstract model can be sent using other mechanisms. Converting the abstract model to a serialized version and sending it to business system server 102 is indicated by blocks 160 and 162, respectively, in FIG. 2. Sending the abstract model to the server in other ways is indicated by block 164.

Unified generator component 126 then generates a unified representation of the business process from the abstract model which it has received. This is indicated by block 166 in FIG. 2. The unified representation captures both server side and client side customizations. As is described below, this unified representation can, itself, be run on the server with client side actions run as no-ops on the server. The unified representation is also used to generate client side representations that can be run on one or more different clients. In one embodiment, the components 114-116 that form the model 112 of the business process are mapped, using mappings 130, to different sets of activities that are performed in performing the business process. Mappings 130 also illustratively indicate where the activities are performed (e.g., client or server) and the types of representations the activities are valid for (e.g., which particular clients, etc.). By way of example, where the subfunction represented by a given component is to create a record in the business system, then the set of activities that maps to that component is a set of activities that is performed in order to create the record in the business system. Accessing the mappings between the components and activities is indicated by block 168 in FIG. 2, and converting the components to the corresponding activities is indicated by block 170. This can be done in a wide variety of different ways. For instance, in one embodiment, the components are converted to the activities by representing them in an extensible markup language (XML) based language that represents executable units of code that are referred to as activities. This, for instance, can be XAML, or any other type of code. The specific embodiment in which the activities are represented in XAML is indicated by block 172 in FIG. 2.

In generating the unified representation of the business process from the model, there may be some activities that are meant to run only on the client. If that is the case, then these activities are represented as no-ops in the unified representation. Thus, when the unified representation is executed on the server, the activities that are meant only for execution on the client will not be performed on the server. Representing the client side only activities in this way is indicated by block 174 in FIG. 2. The unified representation can be generated in other ways as well, and this is indicated by block 176. In any case, the unified representation operates as a single source for representing the various customizations made by the user 102.

Having received the model 112 of the business process and unified process definition (or unified representation) 131, client script generator component 128 can also generate the client script (from the unified representation) that is used to execute the sets of activities that are to be executed on the client. Thus, the component 128 generates a client side language representation of the business process from the unified representation 131. The client side language representation is illustratively a representation that can be executed in a browser on a client. This is indicated by block 178 in FIG. 2. It will be noted that the client side representation can be generated at authoring and storing time or at runtime or when downloaded to a client, or at another time. Also, the unified representation can be used to generate different client representations for different clients, or even different subsystem representations for different subsystems.

In generating the client side language representation, activities that are meant to only be performed on the server are identified, and they are skipped. That is, they are not placed in the client side language representation, so that they are not performed, or attempted, on the client. Also, when multiple different clients are used, multiple different representations can be generated from the unified representation, and mappings 130 can be used to determine which activities are valid for which representations so they can be generated accordingly. Skipping the actions that are meant to be performed only on the server is indicated by block 180 in FIG. 2. In one embodiment, the client side language representation of the business process is a java script representation, as indicated by block 182. It will be noted, however, that it could be another type of client side language representation as well, and this is indicated by block 184.

In the embodiment being discussed, both the unified representation 131 and the client side process definition (or representation) 129 are generated at author time (although the client side definition can be generated later from the unified representation and cached). Thus, in this embodiment, once both the unified definition 131 and the client side process definition 129 have been generated, they are illustratively stored in business system data store 106. This is indicated by block 186 in FIG. 2. They can then be used, during runtime, as described below.

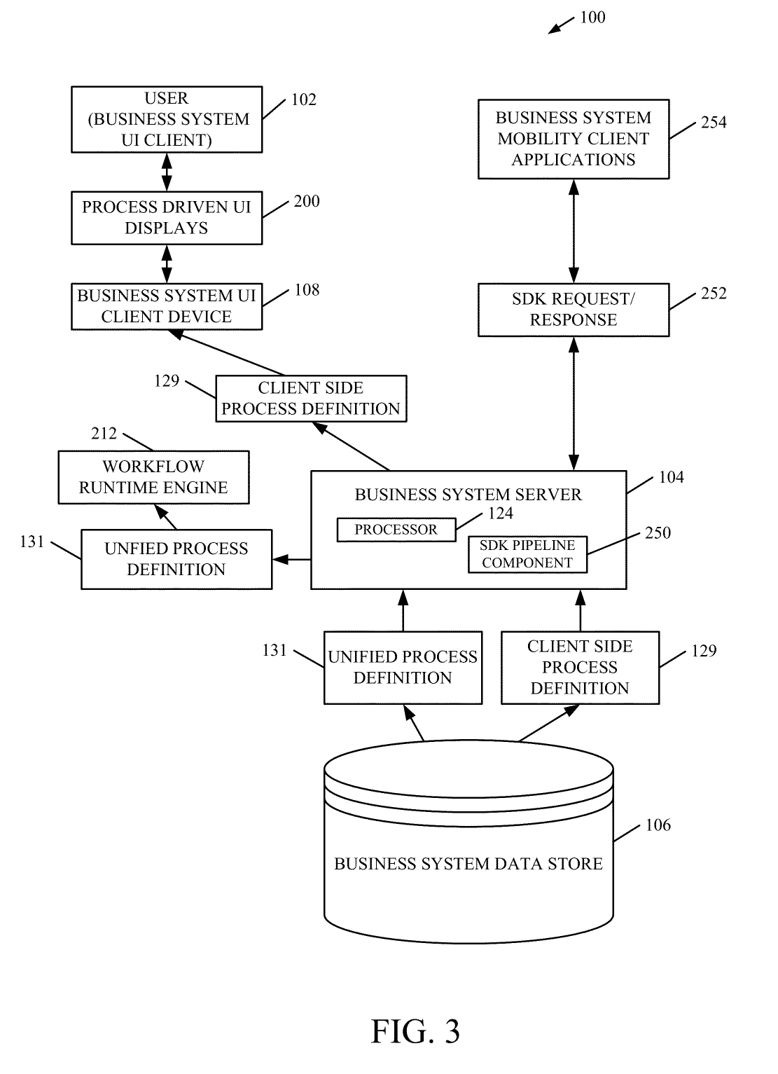

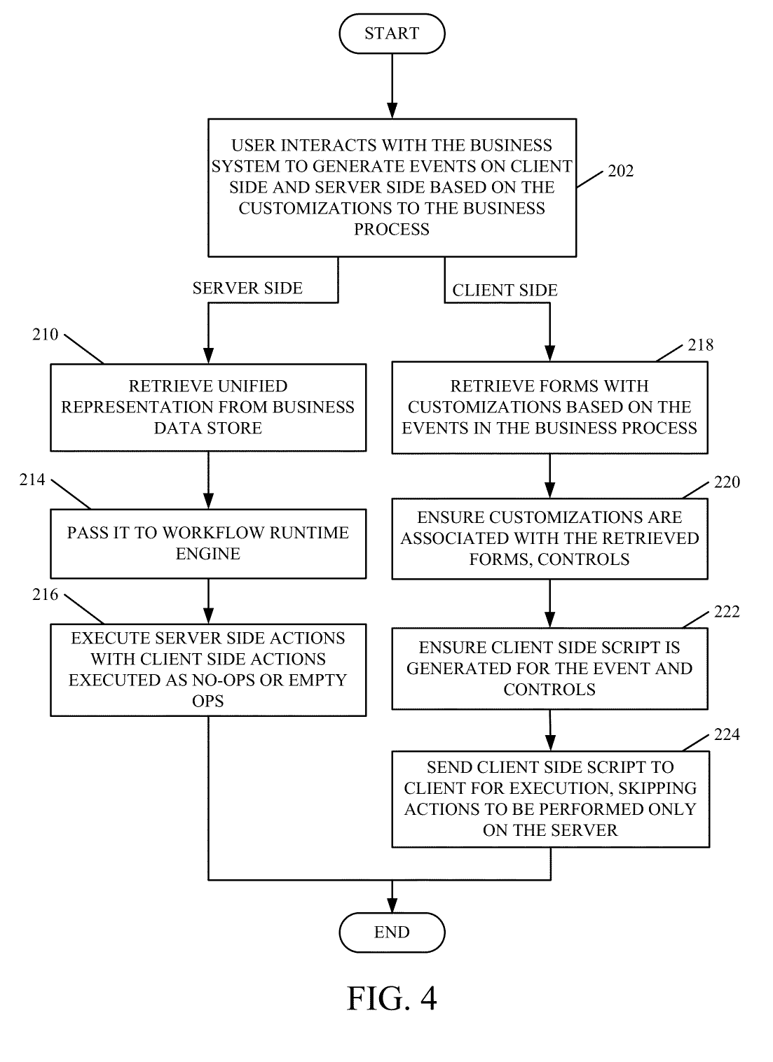

FIG. 3 is another block diagram of architecture 100, except that it is disposed in a runtime environment. FIG. 4 is a flow diagram illustrating one embodiment of the operation of architecture 100 in the runtime environment shown in FIG. 3. FIGS. 3 and 4 will now be described in conjunction with one another.

User 102 (which could of course be a different user than user 102 shown in FIG. 1, or the same user) illustratively interacts with a set of process driven user interface displays 200 to interact with and manipulate, the business system run by client device 108 and business system server 104. The process driven UI displays are illustratively indicated by block 200 in FIG. 3, and it will be understood that it represents multiple displays.

As user 102 interacts with the business system, the interactions will illustratively generate events on the client side or server side (or both) based upon the customizations to the business process that the user made in the authoring environment. By way of example, the user may interact with the business system in order to trigger an event or an action. This is indicated by block 202 in FIG. 4.

Assuming that the client actions trigger events or actions to be performed on the server side, then business system server 104 illustratively retrieves the unified process definition 131 from business system data store 106. This is indicated by block 210 in FIG. 4. Business system server 104 passes unified process definition 131 on to a workflow runtime engine 212 that illustratively executes the unified process definition. Passing the process definition 131 on to the workflow runtime engine 212 is indicated by block 214 in FIG. 4. Workflow runtime engine 212 then executes the various activities on the server side. When an activity or action is to be performed only on the client side, then workflow runtime engine 212 executes it as a no-op or an empty operation. This is indicated by block 216. Workflow runtime engine 212 is only one way to run the customizations. Other runtime components can be generated and used to run the customizations as well.

At block 202, when the client interactions trigger a rule or another activity or action that is to be performed on the server side, then business system server 104 illustratively accesses the client side process definition 129 from business system data store 106. This is indicated by block 218 in FIG. 4. Business system server 104 illustratively ensures that the customizations made to the various forms that are being accessed and retrieved from data store 106 have, indeed, been associated with the retrieved forms. By way of example, if the user has made a customization to a given form, by applying a rule or item of business logic to that form, then business server 104 ensures that the customization has indeed been applied to that form. This is indicated by block 220 in FIG. 4.

Business system server 104 also ensures that the client side script has been generated for the event and the controls on the retrieved form and that they have been hooked to the desired events and controls on the given form. For instance, if the user has made a customization to an event or the controls on the retrieved form, then server 104 ensures that the client side script has been generated for that customization, and associated with that form, so that the form operates in accordance with the customizations made in the authoring environment. Ensuring that client side script is generated is indicated by block 222 in FIG. 4.

Business system server 104 then sends the client side process definition 129 to the business system UI client device 108, for execution. It will be noted that the client side script skips actions that are to be performed only on the server 104 (or by workflow runtime engine 212). Sending the client side script to the client and configuring the client side script so it skips the actions that are to be performed only on the server is indicated by block 224 in FIG. 4. That is, the scripts, which are generated at block 222, are hooked to the events and controls on the forms, and they run as the events are triggered during user interaction with the forms and controls. It will also be noted that business system server 104 can include an SDK pipeline component 250. Component 250 illustratively receives SDK requests and provides SDK responses 252 to business system mobility client applications 254. Applications 254 are illustratively mobile applications that can reside on mobile devices, such as smart phones, tablet computers, laptop computers, etc.

It can be seen that the same representation acts as actual code as well as a pure persistence mechanism where it is regenerated into an abstract memory model. This is the server side language representation. By way of example, a XAML representation not only acts as actual code, which can be run by the workflow runtime engine 212, but it also illustratively acts as the persistence mechanism so that it can be stored in data store 106. It can be converted into the client side code to achieve client side execution in a browser. Thus, the system achieves composite processes which can be a mix of client and server actions or activities based on a single model captured in the authoring environment.

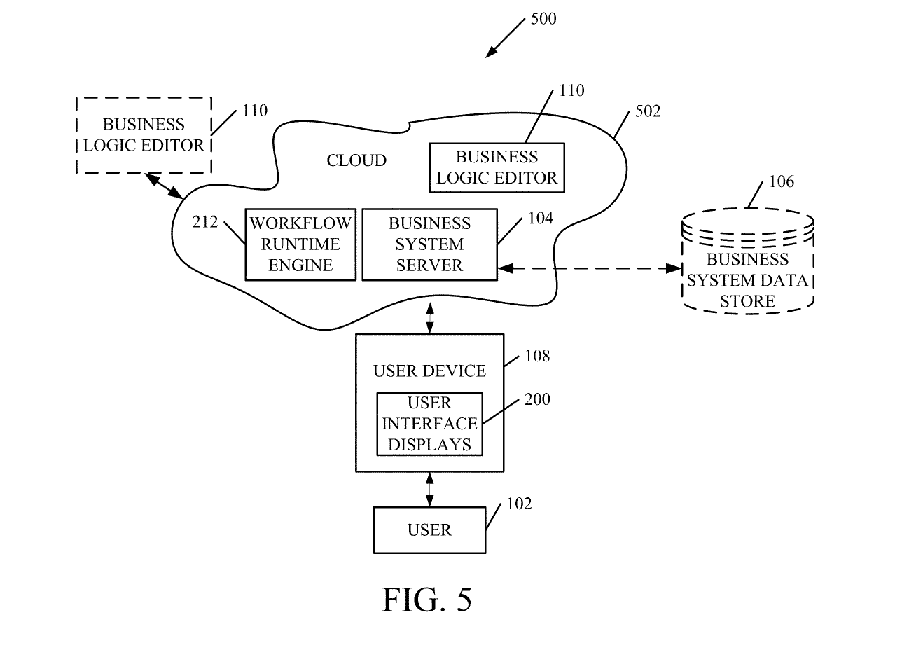

FIG. 5 is a block diagram of architecture 100, shown in FIGS. 1 and 3, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIGS. 1 and 3 and they are similarly numbered. FIG. 5 specifically shows that business system server 104, business logic editor 110 and workflow runtime editor 212 are located in cloud 502 (which can be public, private, or a combination where portions are public while others are private). Therefore, user 102 uses a user device 108 to access those systems through cloud 502.

FIG. 5 also depicts another embodiment of a cloud architecture. FIG. 5 shows that it is also contemplated that some elements of architecture 100 are disposed in cloud 502 while others are not. By way of example, data store 106 can be disposed outside of cloud 502, and accessed through cloud 502. In another embodiment, business logic editor 110 is also outside of cloud 502. Regardless of where they are located, they can be accessed directly by device 108, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

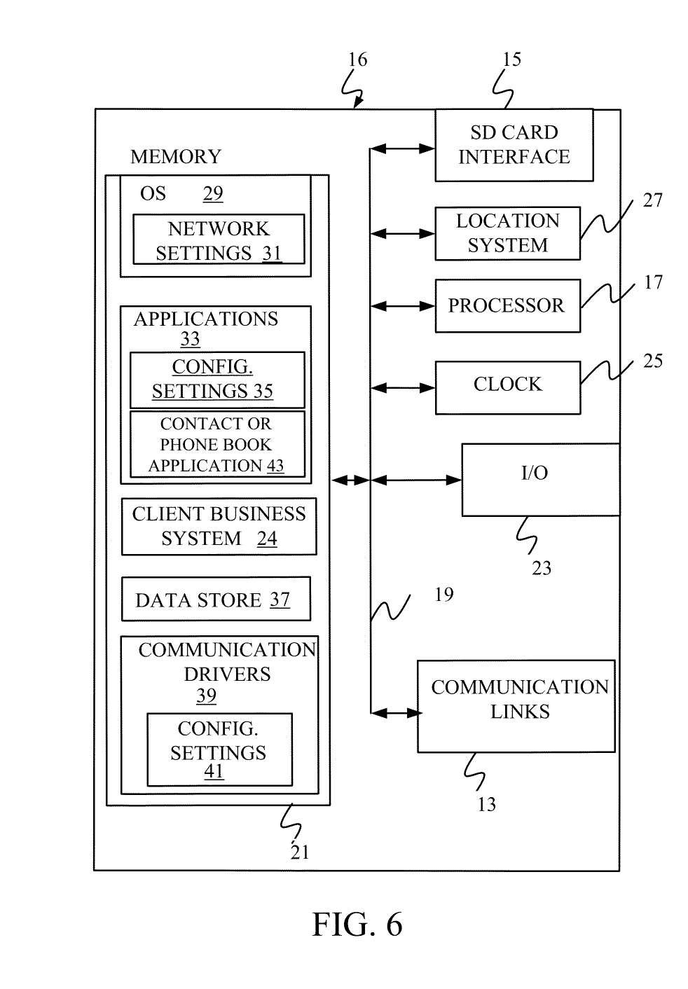

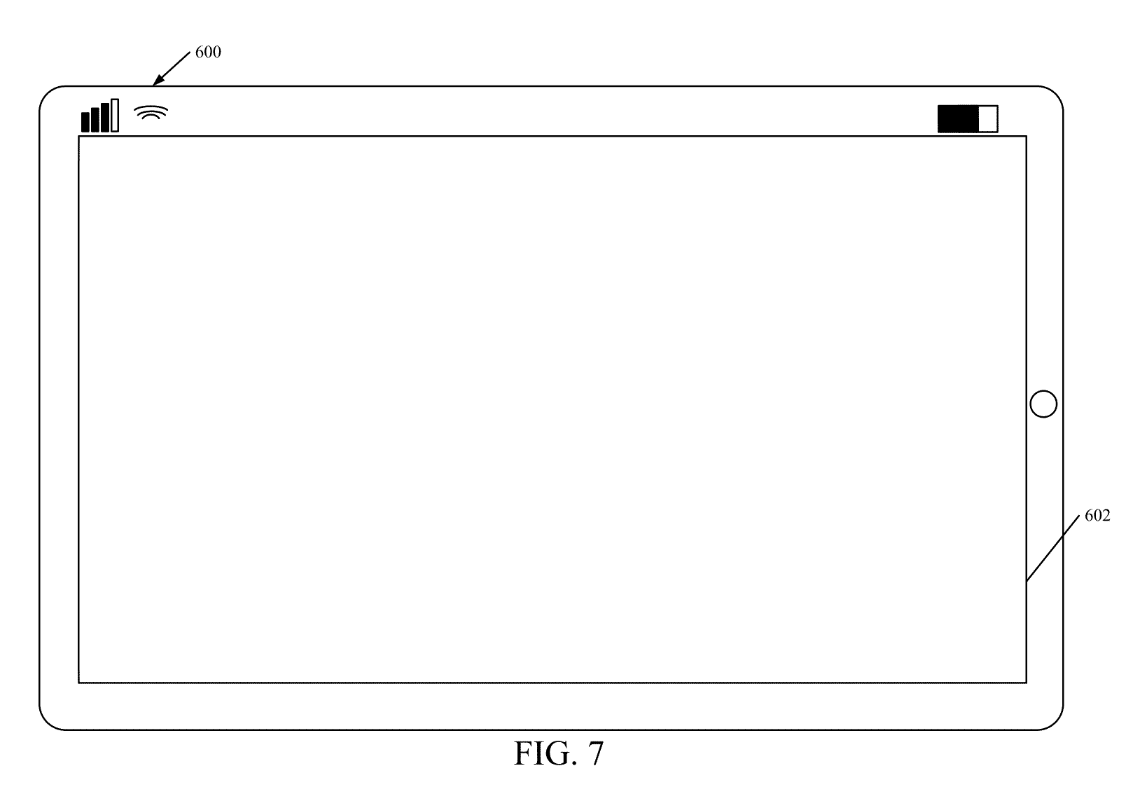

FIG. 6 is a simplified block diagram of one illustrative embodiment of a handheld or mobile computing device that can be used as a user's or client's hand held device 16, in which the present system (or parts of it) can be deployed. FIGS. 7-10 are examples of handheld or mobile devices. A mobile client is also an example of a particular kind of client that client script generator 128 can generate a specific representation for.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 122 or 124 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. It will be noted that, in one embodiment, component 128 generates one client representation and that representation runs consistently on a web browser client, a tablet and mobile clients. This can be done because the client representation interacts with a client API layer that is implemented for each of these different clients and abstracts away the client specific details. However, this need not be the case, and different client representations can be generated for different clients. In FIG. 7, computer 600 is shown with user interface display on the display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

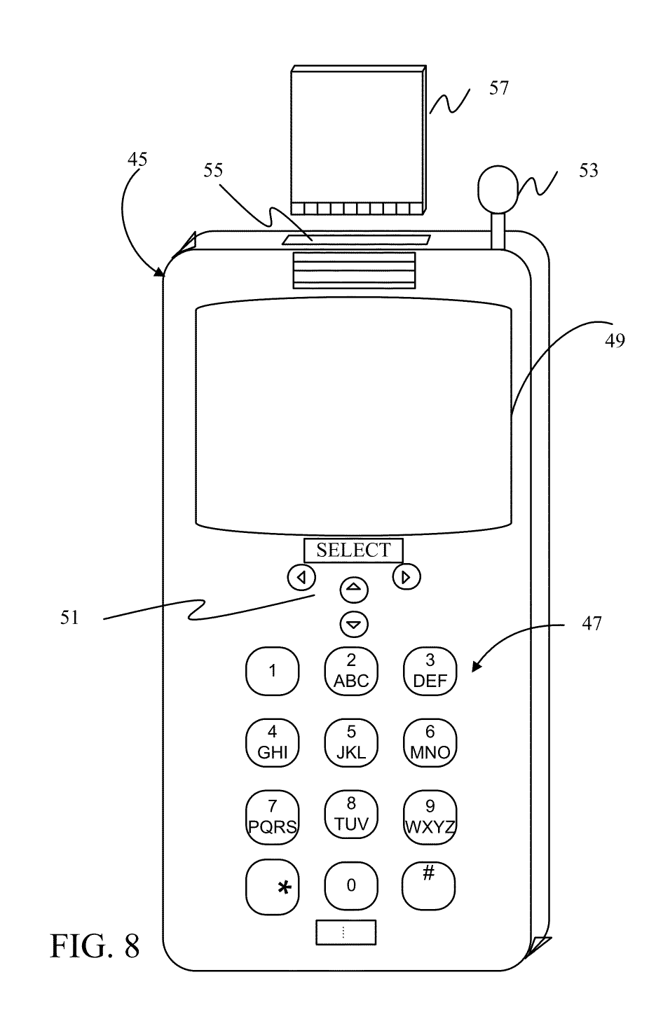

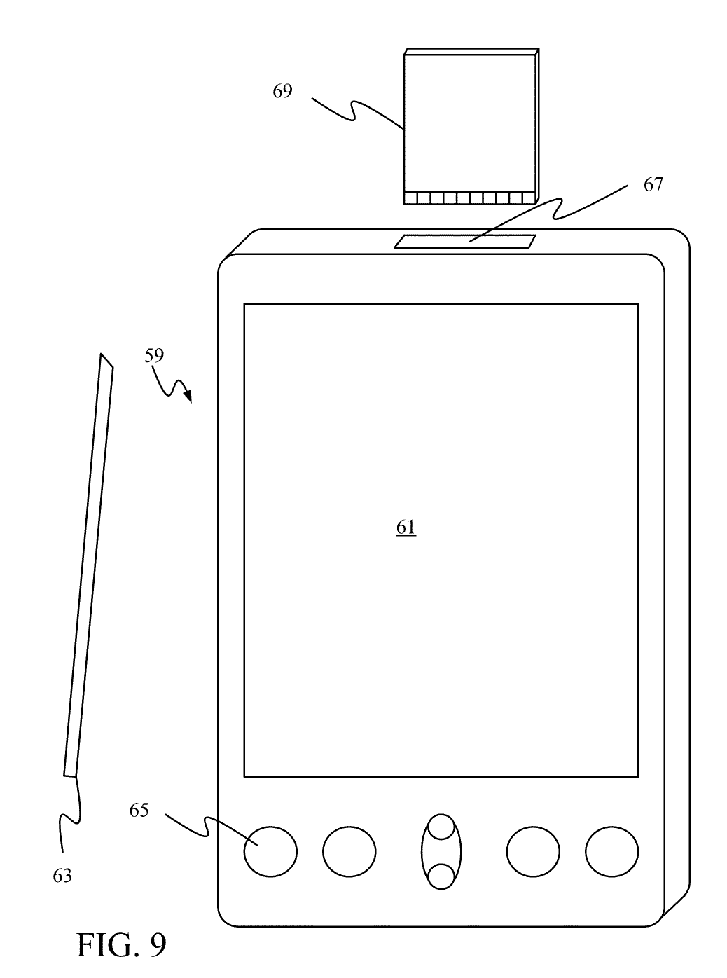

FIGS. 8 and 9 provide additional examples of devices 16 that can be used, although others can be used as well. In FIG. 8, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

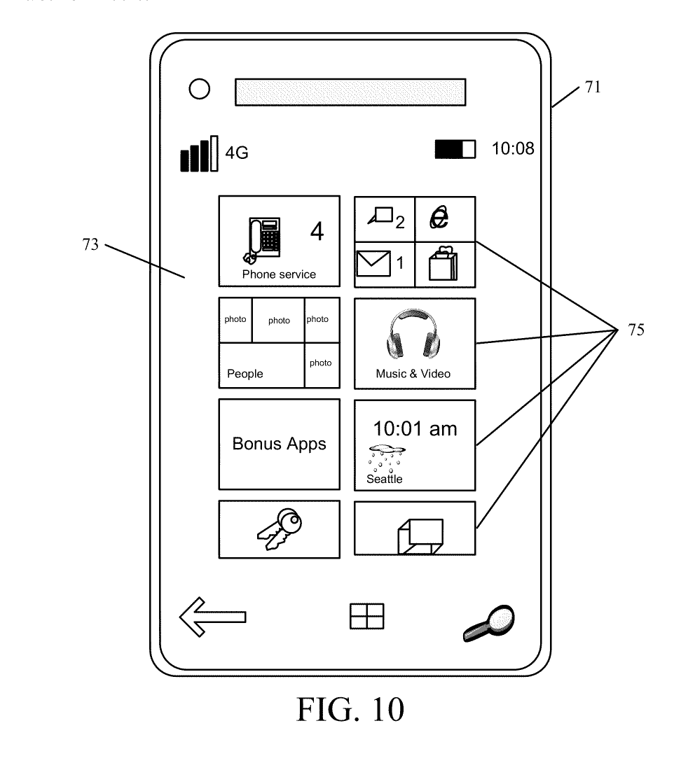

FIG. 10 is similar to FIG. 8 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

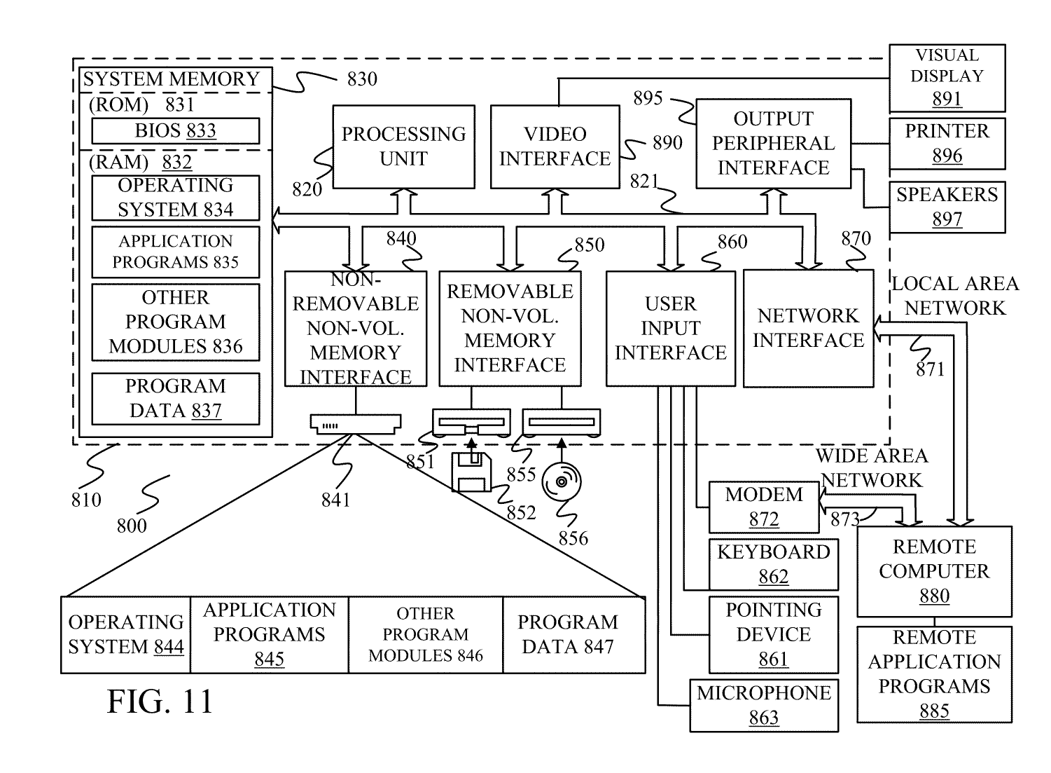

FIG. 11 is one embodiment of a computing environment in which architecture 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 122 or 124), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
receiving a model of a process including user customizations;
generating a unified representation of the model in executable code, the unified representation representing both client side operations and server side operations, the executable code, when executed on a server, defining the client side operations as no-operations; and
storing the unified representation for runtime access.

2. The computer-implemented method of claim 1 wherein the model of the process comprises a model of a business process, including user customizations to the business process, and further comprising:
generating a user interface display with input mechanisms that receive user actuation to make the user customizations to the business process.

3. The computer-implemented method of claim 2 and further comprising:
generating the model of the business process to include process components that model corresponding portions of the business process.

4. The computer-implemented method of claim 3 wherein generating a unified representation comprises:
accessing a set of mappings between the process components in the model and activities to identify a set of activities performed for the corresponding portions of the business process.

5. The computer-implemented method of claim 4 wherein generating a unified representation comprises:
generating a markup language-based representation of the identified activities, the markup language-based representation representing activities performed on a client as no-ops when executed on a server.

6. The computer-implemented method of claim 5 wherein generating a markup language-based representation comprises:
generating an extensible application markup language (XAML) representation.

7. The computer-implemented method of claim 5 and further comprising:
generating, from the unified representation, a client side language representation of the activities performed on the client, the client side language representation skipping activities performed on the server.

8. The computer-implemented method of claim 7 wherein generating a client side language representation comprises:
generating a java script representation of the activities performed on the client.

9. The computer-implemented method of claim 7 wherein generating the model comprises:
generating triggers that trigger activities for corresponding components in the business process.

10. The computer-implemented method of claim 9 and further comprising:
receiving user interaction to trigger server side activities for corresponding components of the business process; and
in response to the trigger, retrieving the markup language-based representation, executing the server side activities, and executing the client side activities in the markup language-based representation as no-ops.

11. The computer-implemented method of claim 9 and further comprising:
receiving user interaction to trigger client side activities for corresponding components of the business process; and
in response to the trigger, executing the activities performed on the client, based on the client side language representation of the activities, skipping the server side activities.

12. A computer system, comprising:
a unified generator component that receives a model of a user-customized process and generates a unified process definition, based on the model, in executable code, the unified process definition representing both client side operations and server side operations; and
a computer processor that is a functional part of the system and is activated by the unified generator component to facilitate generating the unified process definition.

13. The computer system of claim 12 wherein the user-customized process comprises a business process and wherein the model comprises model components that correspond to different portions of the business process.

14. The computer system of claim 13 and further comprising:
a mapping store that stores mappings between the model components and business activities performed by corresponding portions of the business process, the unified generator component accessing the mappings to identify activities represented in the unified process definition.

15. The computer system of claim 14 wherein the unified process definition comprises an extensible application markup language (XAML) representation that represents the client side operations as no-ops.

16. The computer system of claim 14 and further comprising:
a client script generator component that generates, from the unified process definition, a client script to perform the client side operations represented in the unified process definition, the client script excluding the server side operations.

17. A computer readable storage medium that stores computer executable instructions which, when executed by a computer, cause the computer to perform a method, comprising:
receiving a model of a process including user customizations, the model including process components that model corresponding portions of the process;
accessing a set of mappings between the process components in the model and activities to identify a set of activities performed for the corresponding portions of the process;
generating a unified representation of the model in executable code, based on the mappings, the unified representation representing both client side operations and server side operations, the executable code, when executed on a server, defining the client side operations as no-operations; and
storing the unified representation for runtime access.

18. The computer readable storage medium of claim 17 wherein the process comprises a business process and further comprising:
generating a client script representation of the business process from the unified representation, the client script representation skipping the server side operations.

19. The computer readable storage medium of claim 18 wherein generating a unified representation comprises:
generating an extensible application markup language (XAML) representation as the executable code to run the server side operations and as a persistence mechanism that is used to generate the client script representation.

20. The computer readable storage medium of claim 19 and further comprising:
receiving user inputs at a business logic editor to generate the model of the business process including the user customizations to the business process.
